(19) United States
(12) Patent Application Publication
(10) Pub. No.: US 2017/0056938 A1
(43) Pub. Date: Mar. 2, 2017

(54) DEVICE FOR CLEARING AN AREA AROUND ELEVATED OBJECTS

(71) Applicant: GENIX DÉVELOPPEMENT, Ville d'Anjou (CA)

(72) Inventors: Jean-Guy PELLETIER, Donnacona (CA); Jean-Luc NAUD, Lanoraie (CA)

(21) Appl. No.: 15/308,137

(22) PCT Filed: May 5, 2015
(86) PCT No.: PCT/CA2015/000295

§ 371 Date: Nov. 1, 2016

Related U.S. Application Data
(60) Provisional application No. 61/988,596, filed on May 5, 2014.

(51) Int. Cl. B08B 5/02; B08B 13/00; E01H 1/00; A46B 13/02; A46B 13/00; B08B 1/00; B08B 1/04

(52) U.S. Cl. CPC B08B 5/02; B08B 1/002; B08B 13/00; B08B 1/04; B08B 1/008; A46B 13/02; A46B 13/005; E01H 1/005; E01H 1/003

(57) ABSTRACT

The present document describes a device for clearing an area around an elevated object. The device comprises: a main frame; a blower device operably mounted on the main frame for blowing high flow air towards the area around the elevated object; and a sweeping device operably mounted to and extending from the main frame for clearing the area around the elevated object. The present document further describes a method for clearing the area around an elevated object.

### CROSS-REFERENCE TO RELATED APPLICATIONS

This application claims priority of U.S. provisional patent application no. 61/988,596, filed on May 5, 2014, the specification of which is hereby incorporated by reference.

### BACKGROUND

(a) Field

The subject matter disclosed generally relates to industrial maintenance equipment. More particularly, the subject matter disclosed relates to devices and methods for clearing an area around objects.

(b) Related Prior Art

Various types of indicators such as signs and lights are used to direct aircraft pilots both into and around an airfield, for example, by marking the edges of a runway.

These indicators can be flush with the ground or recessed or can be elevated both to allow the pilots to see them from a distance and to keep them visible when particles, such as snow, sand, dust and/or debris, fall around them. As to the indicators that are flush with the ground or recessed, accumulations, such as snowfall can hide them from view.

Even when these objects are elevated, snow and ice tend to build up around them, especially in climates with heavy snowfall accumulation, or the snow can be pushed onto them from an adjacent runway surface.

Such buildup of particles must be removed to keep the lights and signs visible at all times.

The lights and signs are very delicate and it is difficult to remove accumulations of particles around them without damaging them. Conventional snow blowers, plows or sweepers cannot remove the snow from these lights and signs. Many airports currently send crews of workers to remove the buildup. These crews manually remove the buildup with hand shovels and brooms. Such a task is a very labor-intensive and time-consuming process requiring the closure of adjacent surfaces for safety.

On the other hand, there exists on the market devices for clearing an area around elevated objects. For example, U.S. Pat. No. 7,861,347 to McKeown et al. discloses a vehicle for removing an accumulation of particles, which includes a vehicle body, a system configured to remove the particles in bulk and an arm coupled to and extending from the vehicle body. The arm includes first and second sweeping elements for cleaning around the elevated obstacles. Experience has shown that the first and second sweeping elements are not sufficient for properly clearing an area around the elevated obstacles. The addition of the conventional snow blower (i.e., motor-powered blades for taking a large accumulation of snow in an thrusting it out through a spout) adds complexity and bulkiness to the equipment, does not give satisfactory results in clearing an area around the elevated obstacles, and is not useful for other types of debris apart from snow accumulations.

Other companies have developed products that are intended to clean snow and debris around elevated objects. For all of these products, again, the systems are configured to remove the particles “in bulk” around the elevated objects, but is not configured to clear an area around an elevated object to the operator's satisfaction (i.e., Tellefsdal, Argnani & Monti, etc.).

Furthermore, other companies have developed products that are intended to clean snow and debris around elevated objects. Usually, these products include a snow blower for removing snow and debris on the surface around the elevated objects, but also from around the elevated objects. However, such devices usually cannot clean snow and debris that are buildup on the elevated objects that have not been removed easily using the snow blower. Hand shovels and brooms are therefore, again, needed. Additionally, the size of these vehicles are usually important and need to include an air compressor for using with the snow blower.

It is to be noted that various types of elevated objects, other than signs and lights used to direct pilots both into and around an airfield, need to be cleaned from snow and debris (i.e., fire hydrants, traffic and parking signs, other indicators, etc.)

There is therefore a need for devices and methods for clearing an area around elevated objects that are convenient and efficient.

### SUMMARY

According to an embodiment, there is provided a device for clearing an area around an elevated object, the device comprising: a main frame; a blower device operably mounted on the main frame for blowing high flow air towards the area around the elevated object; and a sweeping device operably mounted to and extending from the main frame for clearing the area around the elevated object.

According to another embodiment, the blower device comprises a rotary blower comprising: a main frame portion mounted to the main frame; and a turbine rotatably mounted within the main frame portion for providing the high flow air.

According to a further embodiment, the blower device further comprises a motor in driving arrangement with the turbine for operating the rotary blower.

According to yet another embodiment, the blower device further comprises a high flow air outlet fluidly connected to the rotary blower for allowing the high flow air to exit the blower device in at least one of: a direction towards a surface around the elevated object and a direction towards the elevated object.

According to another embodiment, the high flow air outlet is displaceable relative to the main frame, thereby allowing the blower device to direct the high flow air towards at least one of: the surface around the elevated object and the elevated object.

According to a further embodiment, the blower device further comprises an opening on the main frame portion for allowing entry of air into the rotary blower.

According to yet another embodiment, the device further comprises: a fuel engine mounted on the main frame; a transmission clutch in driving arrangement between the fuel engine and the rotary blower; and an hydraulic pump in arrangement between the fuel engine and the sweeping device.

According to another embodiment, the device further comprises a valve hydraulically connected to the hydraulic pump and the sweeping device.

According to a further embodiment, the device further comprises: an hydraulic motor mounted on the main frame and in driving arrangement with the rotary blower.

According to yet another embodiment, the hydraulic motor is driven by auxiliary hydraulics from a vehicle to which the device is mountable.

According to another embodiment, the device further comprises a valve hydraulically connected to the auxiliary hydraulics from the vehicle, the valve being electrically connected with the sweeping device.

According to a further embodiment, the device further comprises a computer system for monitoring a location of the elevated object and displacing at least one of: a vehicle to which the device is mountable, the main frame, the blower device and the sweeping device based on the monitored location of the elevated object.

According to yet another embodiment, at least one of: the main frame, the blower device and the sweeping device further comprises a light element for illuminating the elevated object.

According to another embodiment, the sweeping device comprises: a first sweeping element comprising a first shaft member rotatable about a first longitudinal axis, and comprising a first set of bristles projecting away from the first longitudinal axis along the first shaft member; and a second sweeping element comprising a second shaft member rotatable about a second longitudinal axis distant from the first longitudinal axis, and comprising a second set of bristles projecting away from the second longitudinal axis along the second shaft member; wherein the first and second shaft members rotate in proximity of the elevated object for clearing the area around the elevated object.

According to a further embodiment, the sweeping device further comprises: a first arm mounted on and extending from the main frame; and a second arm mounted on and extending from the main frame; the first and second arms connecting respectively the first and second shaft members to the main frame.

According to yet another embodiment, the first and second arms are respectively pivotably mounted on the main frame, thereby allowing the first sweeping element and the second sweeping element to be independently displaced relative to the main frame before.

According to another embodiment, the sweeping device further comprises a sweeping motor operatively coupled to the first and second shaft members for operating the first and second shaft members respectively.

According to a further embodiment, the device further comprises a receiving structure on the main frame for mounting the main frame on a vehicle.

According to another embodiment, there is provided a method for clearing an area around an elevated object, the method comprising: blowing high flow air towards the area around the elevated object; and sweeping the area around the elevated object using a sweeping element.

According to a further embodiment, the sweeping the area around the elevated object using a sweeping element comprises: sweeping the area around the elevated object using at least two distant sweeping elements, whereby the elevated object passes between the at least two distant sweeping elements.

Features and advantages of the subject matter hereof will become more apparent in light of the following detailed description of selected embodiments, as illustrated in the accompanying figures. As will be realized, the subject matter disclosed and claimed is capable of modifications in various respects, all without departing from the scope of the claims. Accordingly, the drawings and the description are to be regarded as illustrative in nature, and not as restrictive and the full scope of the subject matter is set forth in the claims.

### BRIEF DESCRIPTION OF THE DRAWINGS

Further features and advantages of the present disclosure will become apparent from the following detailed description, taken in combination with the appended drawings, in which:

FIG. 1 is a top perspective view from one side of a device for clearing an area around an elevated object in accordance with an embodiment;

FIG. 2 is a top perspective view from another side of the device for clearing an area around an elevated object of FIG. 1;

FIG. 3 is another perspective view from the other side of the device for clearing an area around an elevated object of FIG. 1;

FIG. 4 is a bottom perspective view of the device for clearing an area around an elevated object of FIG. 1;

FIG. 5 is a top perspective view from the other side of the device for clearing an area around an elevated object of FIG. 1, showing the device without its cover;

FIG. 6 is a top perspective view from the other side of the device for clearing an area around an elevated object of FIG. 1, showing the device without its cover;

FIG. 7 is a top perspective view from the one side of the device for clearing an area around an elevated object of FIG. 1, showing the device without its cover;

FIG. 8 is a front elevation view of the device for clearing an area around an elevated object of FIG. 1;

FIG. 9 is a side elevation view of the device for clearing an area around an elevated object of FIG. 1;

FIG. 10 is a front elevation view of the device for clearing an area around an elevated object of FIG. 1, showing the device without its cover;

FIG. 11 is a top plan view of the device for clearing an area around an elevated object of FIG. 1, showing the device without its cover;

FIG. 12 is top plan view of the device for clearing an area around an elevated object of FIG. 1;

FIG. 13 is a rear elevation view of the device for clearing an area around an elevated object of FIG. 1;

FIG. 14 is a rear elevation view of the device for clearing an area around an elevated object of FIG. 1, showing the device without its cover;

FIG. 15 is a side elevation view of the device for clearing an area around an elevated object of FIG. 1, showing the device without its cover;

FIG. 16 is a top plan view of the device for clearing an area around an elevated object of FIG. 1, showing the device without its cover;

FIG. 17 is a front elevation view of the device for clearing an area around an elevated object of FIG. 1, showing the blower device in its lowermost position;

FIG. 18 is a front elevation view of the device for clearing an area around an elevated object of FIG. 1, showing the device without its cover and the blower device in its uppermost position;

FIG. 19 is a top perspective view of the device for clearing an area around an elevated object of FIG. 1, showing the blower device in its lowermost position;

FIG. 20 is a front elevation view of the device for clearing an area around an elevated object of FIG. 1, showing the device without its cover and the blower device in its lowermost position;

FIG. 21 is a top perspective view of the device for clearing an area around an elevated object of FIG. 1, showing the blower device in its uppermost position;

FIG. 22 is a front elevation view of the device for clearing an area around an elevated object of FIG. 1, showing the blower device in its uppermost position;

FIG. 23 is a top perspective view of the device for clearing an area around an elevated object of FIG. 1, showing the device without its cover and showing the sweeping device in its substantially vertical position;

FIG. 24 is a top perspective view of the device for clearing an area around an elevated object of FIG. 1, showing the device without its cover and showing the sweeping device in its substantially inclined position;

FIG. 25 is a top perspective view of the device for clearing an area around an elevated object of FIG. 1, showing the sweeping device in its substantially inclined position;

FIG. 26 is a top perspective view of the device for clearing an area around an elevated object of FIG. 1, showing the sweeping device in its substantially vertical position;

FIG. 27 is a front elevation view of the device for clearing an area around an elevated object of FIG. 1, showing the cover in a position between its fully closed position and its fully opened position;

FIG. 28 is a front elevation view of the device for clearing an area around an elevated object of FIG. 1, showing the cover in its fully opened position;

FIG. 29 is a front elevation view of the device for clearing an area around an elevated object of FIG. 1, showing the cover in its fully closed position;

FIG. 30 is a top perspective view of the device for clearing an area around an elevated object of FIG. 1, showing the cover in its fully opened position;

FIG. 31 is a top plan view of the sweeping device of the device for clearing an area around an elevated object of FIG. 1, showing in more details a shock absorber mechanism;

FIG. 32 is a top plan view of the sweeping device of the device for clearing an area around an elevated object of FIG. 1, showing in more details the shock absorber mechanism;

FIG. 33 is a closed-up view of the shock absorber mechanism of the sweeping device of FIGS. 31-32;

FIG. 34 is another closed-up view of the shock absorber mechanism of the sweeping device of FIGS. 31-32;

FIG. 35 is a schematic showing a device for clearing an area around an elevated object operated by a fuel engine and a hydraulic pump in accordance with another embodiment; and

FIG. 36 is a schematic showing a device for clearing an area around an elevated object operated by a hydraulic engine and auxiliary hydraulic from a vehicle in accordance with a further embodiment.

It will be noted that throughout the appended drawings, like features are identified by like reference numerals.

### DETAILED DESCRIPTION

In embodiments, there are disclosed devices for clearing an area around elevated objects and methods for clearing an area around elevated objects. An area is defined as any particular extent of space or surface; e.g., it may include the ground around the elevated objects, the three-dimensional space around the elevated objects, and/or the surface of the elevated objects.

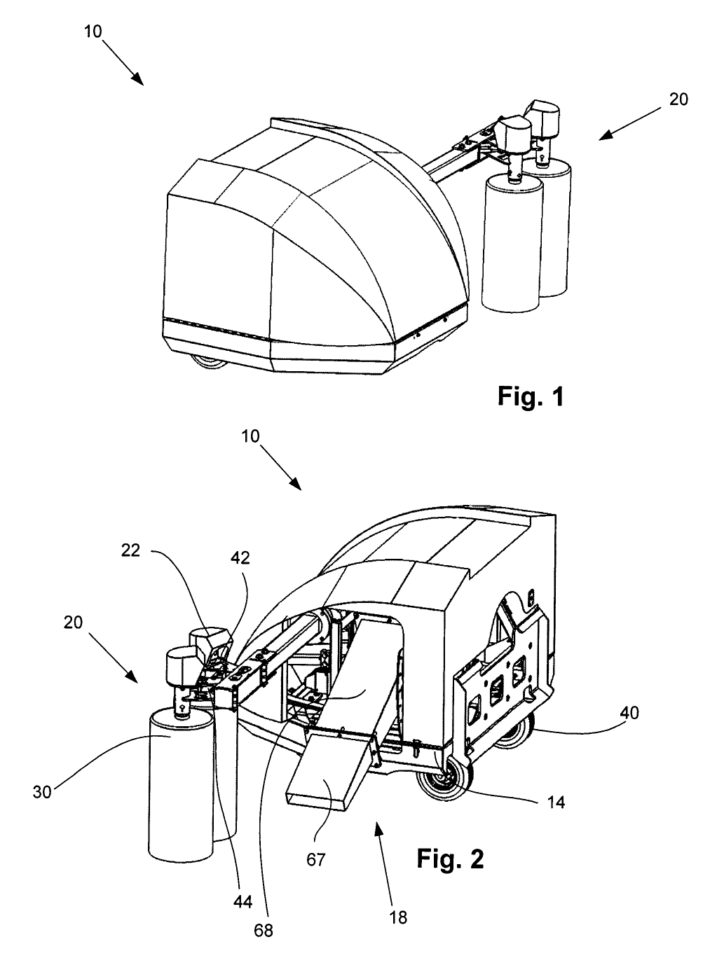

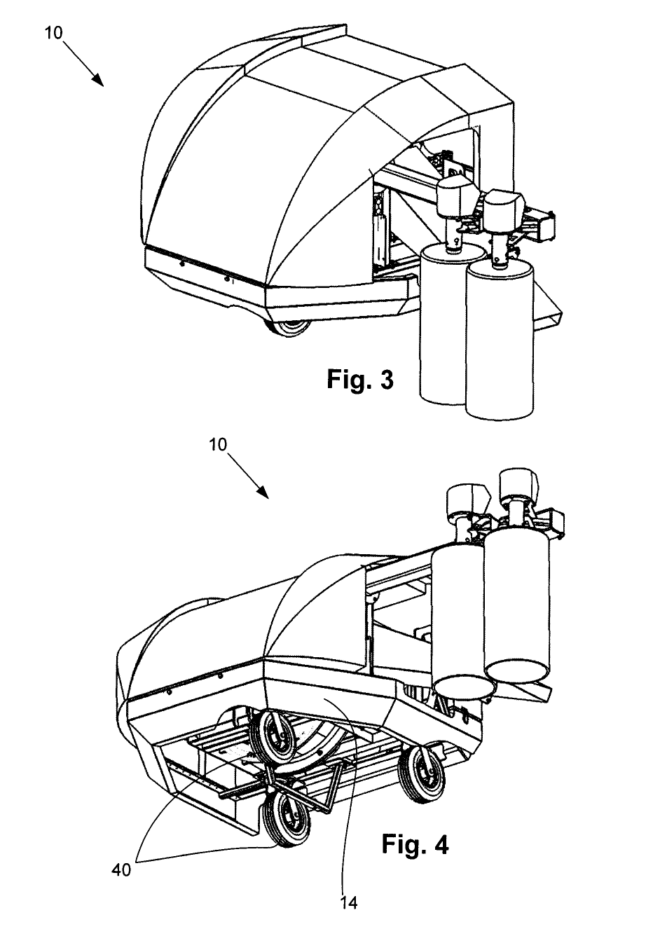

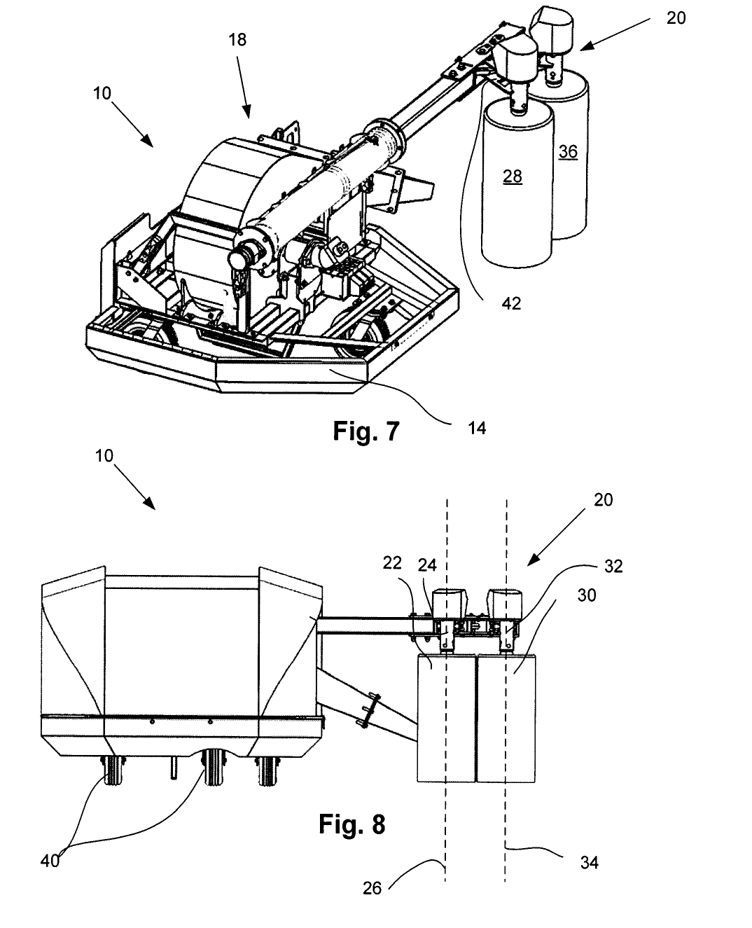

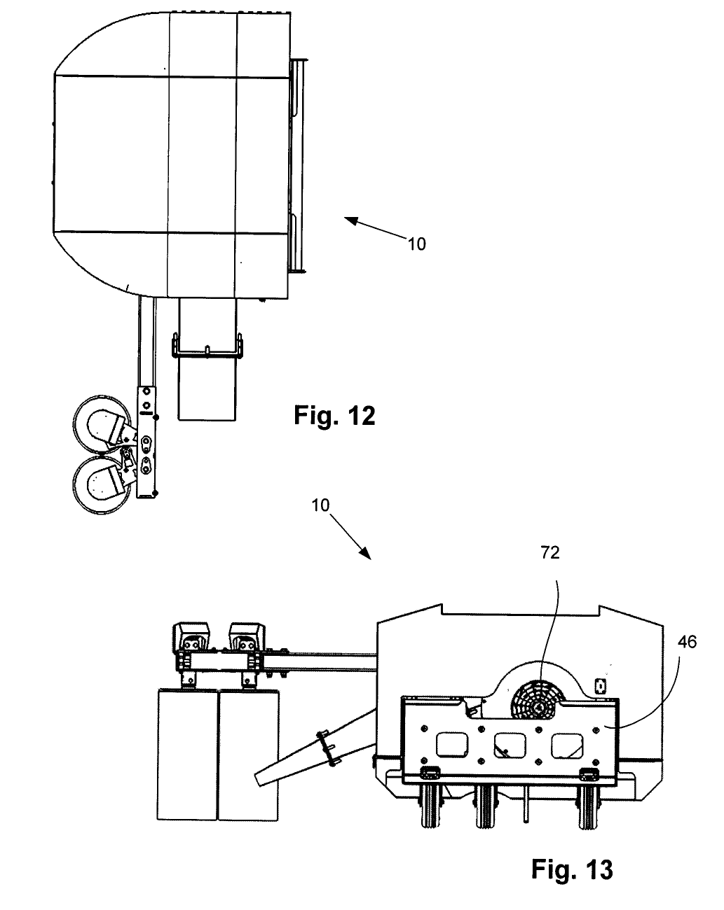

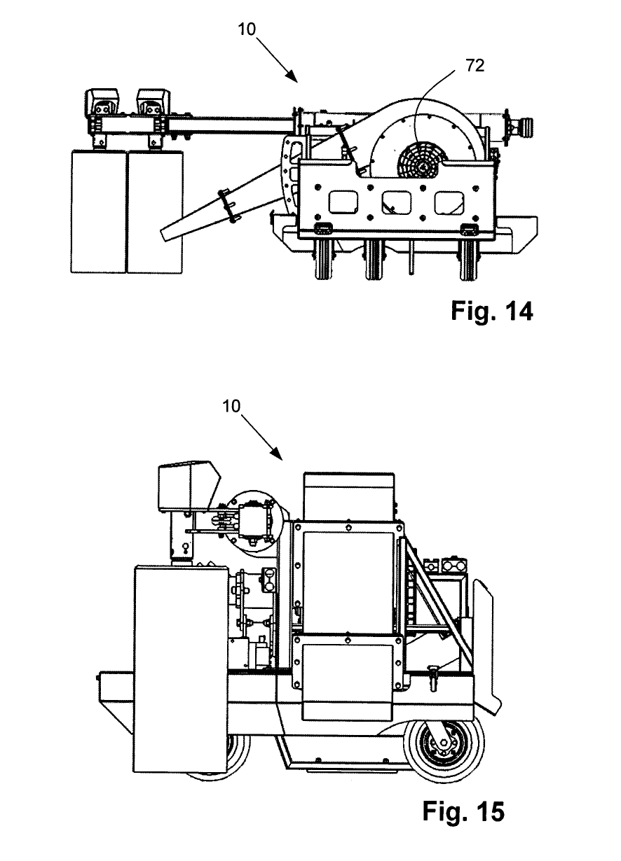

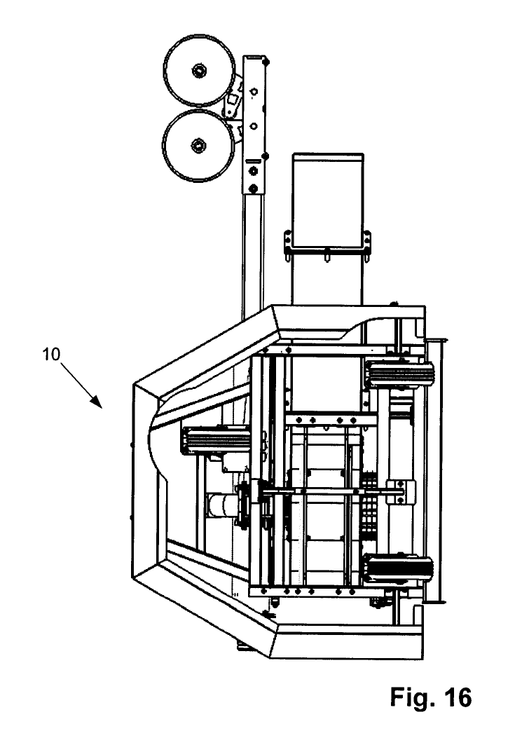

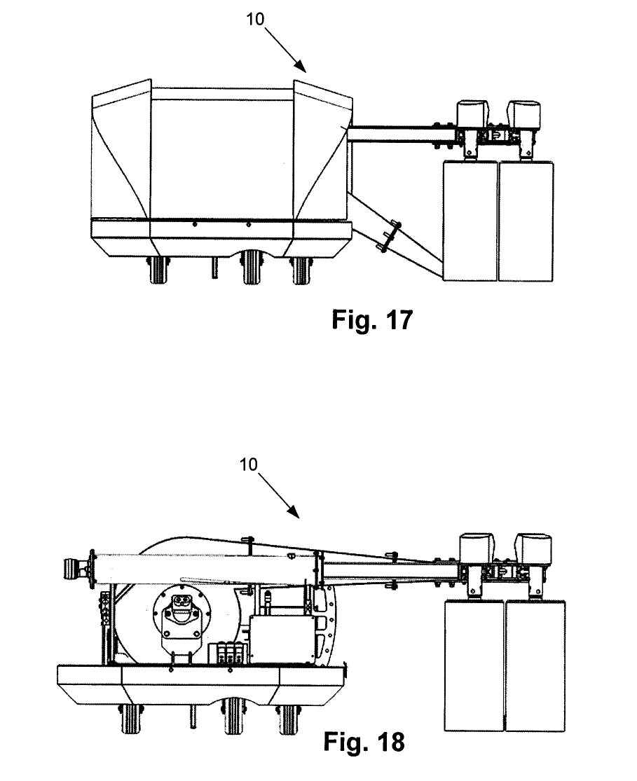

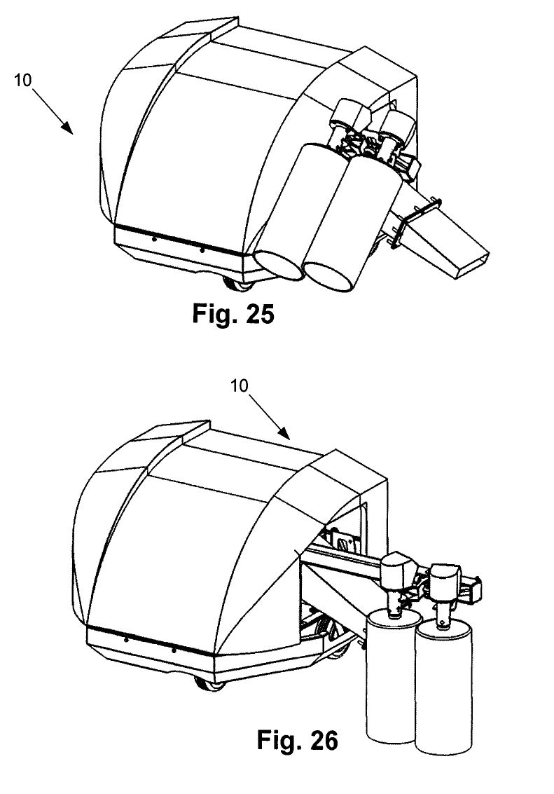

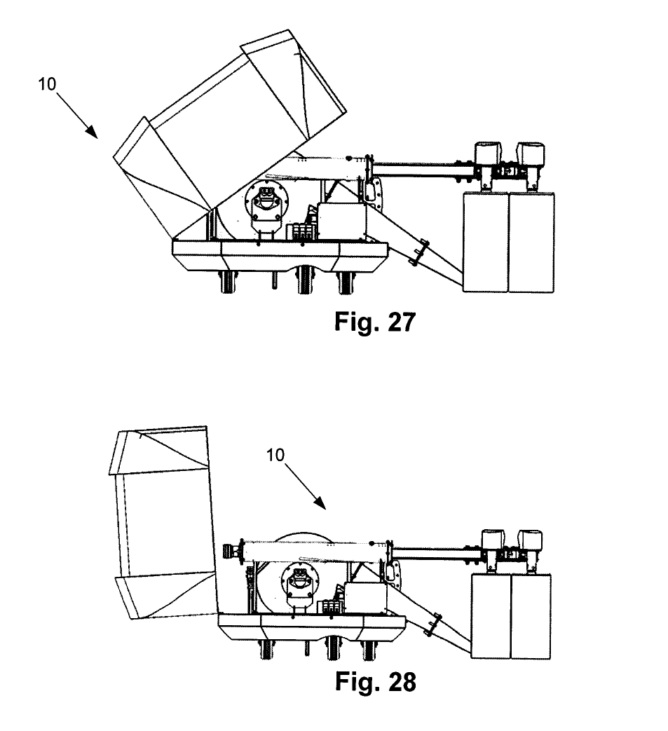

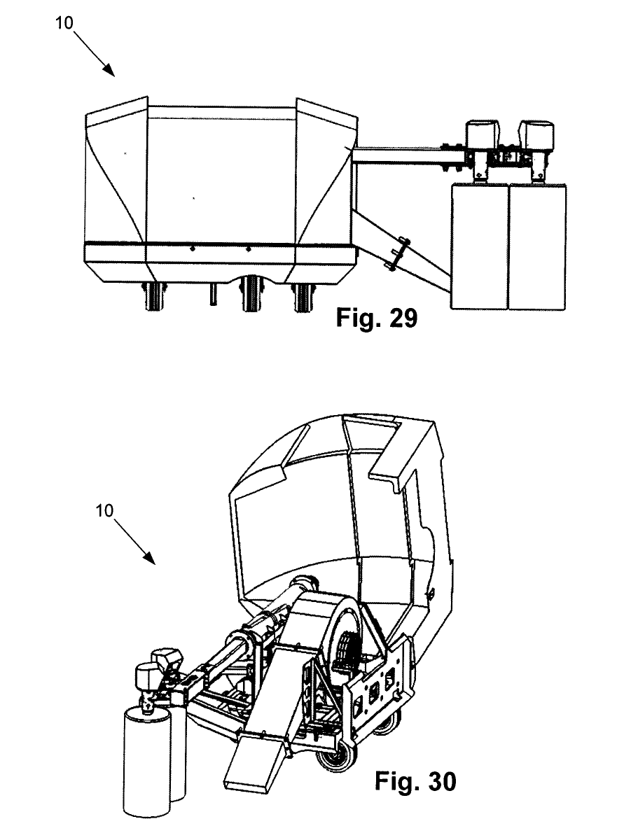

Referring now to the drawings, and more particularly to FIGS. 1-30, there is shown a device 10 for clearing particles from and around an elevated object (not shown). The device 10 includes a main frame 14 for mounting on a vehicle (not shown). The device 10 further includes a blower device 18 (also referred to herein as a rotary blower) operably mounted on the main frame 14 for clearing the particles from and around the elevated object. The device 10 also includes a sweeping device 20 which is operably mounted to and extends from the main frame 14 for clearing the particles from the elevated object. The sweeping device 10 includes a first sweeping element 22. The first sweeping element 22 includes a first shaft member 24 which is rotatable about a first longitudinal axis 26. The first sweeping element 22 also includes a first set of bristles 28 projecting away from the first longitudinal axis 26 along the first shaft member 24. The sweeping device 20 further includes a second sweeping element 30. The second sweeping element 30 includes a second shaft member 32 which is rotatable about a second longitudinal axis 34 that is distant from the first longitudinal axis 26, as best shown in FIG. 8. The second sweeping element 30 further includes a second set of bristles 36 that are projecting away from the second longitudinal axis 34 along the second shaft member 32. The first and second shaft members 24, 32, in their configuration, rotate in proximity to the elevated object for removing particles therefrom.

The vehicle may be of any type which is adapted to receive the device 10 or that a person of ordinary skill in the art can modify to receive the device 10. As such, the vehicle may be, without limitation, a loader, a bull-dozer, a truck, a tractor, a sports utility vehicle or any other vehicle for receiving the device 10 as described herein. It is to be noted that it is not necessary to attach or to mount the device 10 on a vehicle, as the device 10 can alternatively be self-propelled (i.e., like a self-propelled snow blower).

The vehicle may have an operator compartment. The vehicle may be operated by a steering wheel or other types of controls and may also be human powered via handles similar to a walk-behind snow blower.

The main frame 14 of the device 10 mounted on the vehicle may be supported by wheels 40, as shown in FIGS. 1-30, or tracks, skis and the like.

The vehicle, apart from the device 10, may further include a particle removal system (not shown, such as a snow blower, a plow, a sweeper and the like), used to remove an accumulation of particles such as snow, leaves, ice, sand, and the like.

The device 10 may be mounted in front of the vehicle. However, it is to be mentioned that the device 10 may be mounted at the rear, to the side, above or even below the vehicle.

It is also to be mentioned that the main frame 14 of the device 10 may be removably mounted to the vehicle, permanently mounted to the vehicle or may be part of the vehicle.

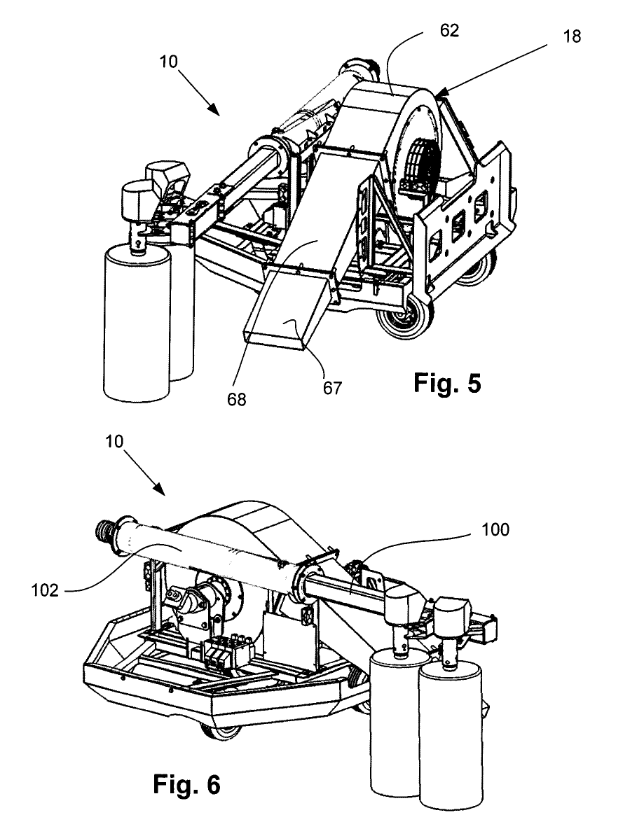

As shown in FIGS. 5 and 6, the blower device 18 of the device 10 includes rotary blower which comprises a main frame portion 62 mounted to the main frame 14 of the device 10 about a blower shaft 63 and a turbine rotatably mounted within the main frame portion 62 for providing high flow air, or alternatively high pressurized air, exiting the blower device 18. The blower device 18 further includes a motor (not shown) for operating the rotary blower and a high flow air outlet 68 fluidly connected to the rotary blower and defining a nozzle 67 for allowing the high flow air (or the high speed jet/stream air) to exit the blower device 18 in a direction towards a surface around the elevated object and/or in a direction towards the elevated object. It is to be mentioned that the high flow air outlet 68, with the ground surface, defines an angle, and that that angle may vary depending on the direction that the operator wants the high flow air to exit the snow blower device 18. For example, where the particles on the surface near the elevated object include ice particles, the operator of the device 10 may want to align the high flow air outlet 68 (or the nozzle 67) substantially parallel to the ground surface such as to help in detaching the ice particles from the ground surface. In other scenarios, the operator of the device 10 may want to align the high flow air outlet (or the nozzle) 68 with a substantial angle relative to the ground surface.

It is to be mentioned that the high flow air outlet 68 (and thus the nozzle 67) may be displaceable relative to the main frame 14 of the device 10 and/or relative to the vehicle such as to allow an operator to direct the high flow air outlet 68 towards the surface to be cleaned and/or towards the elevated object to be cleaned.

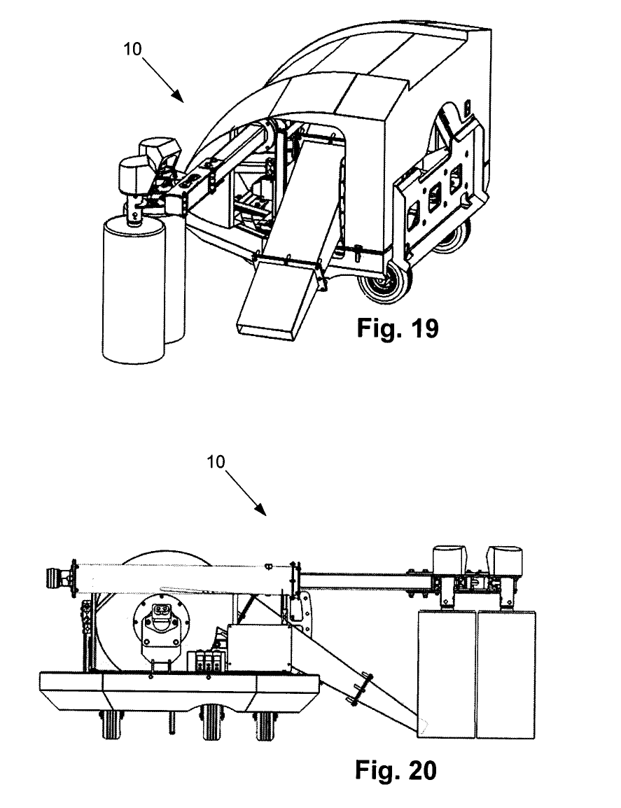

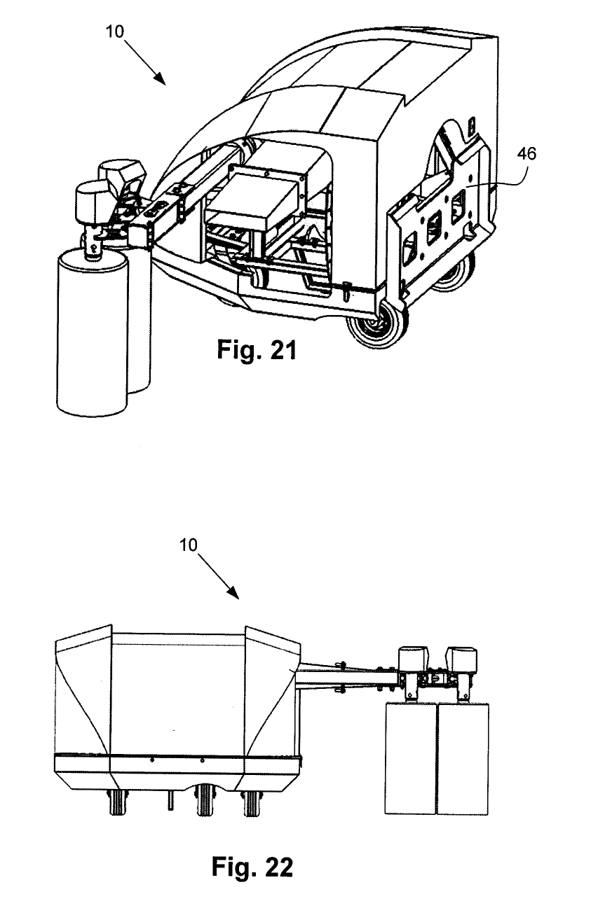

The blower device 18 may thus further include a cylinder connected between the high flow air outlet 68 and the nozzle 67, such as a hydraulic cylinder (not shown), to allow the nozzle 67 to be vertically displaceable relative to the high flow air outlet 68. Alternatively, and as better shown in FIGS. 19 and 21, the main frame portion 62 of the blower device 18, which is rotatably mounted on the blower shaft 63, may rotate to allow the high flow air outlet, and thus the nozzle 67, to be displaced between a lowermost position (FIG. 19) and an uppermost position (FIG. 21).

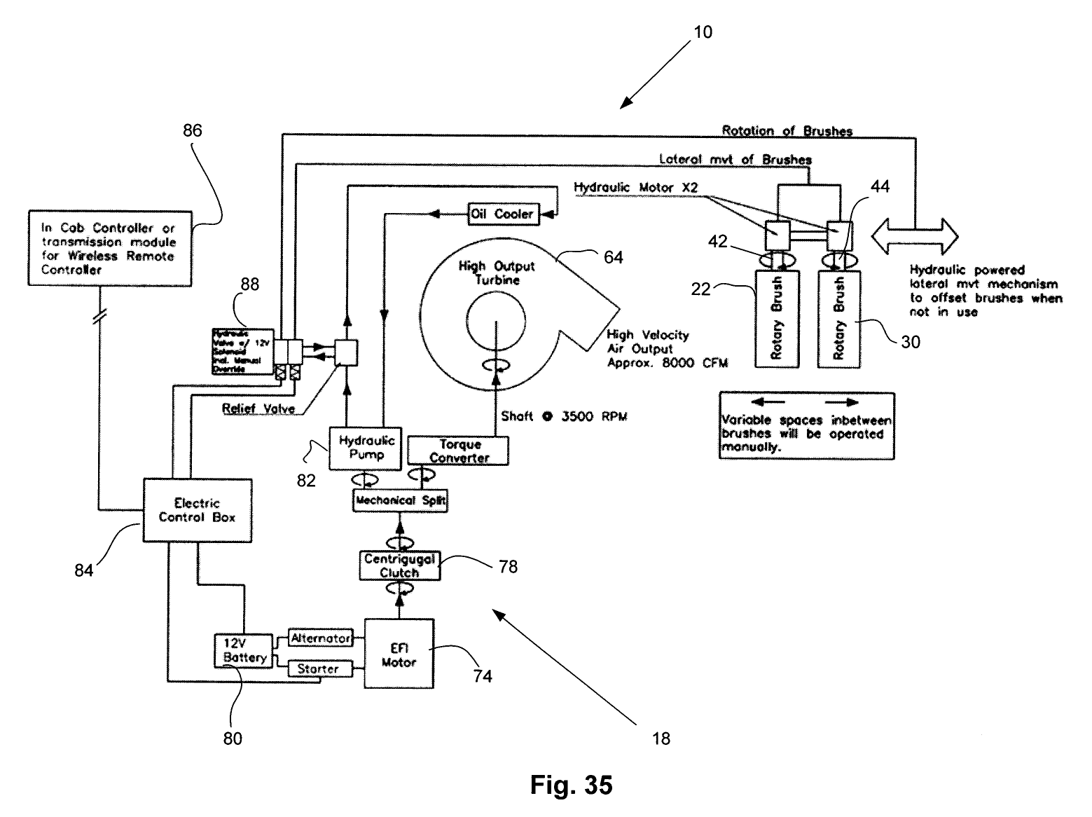

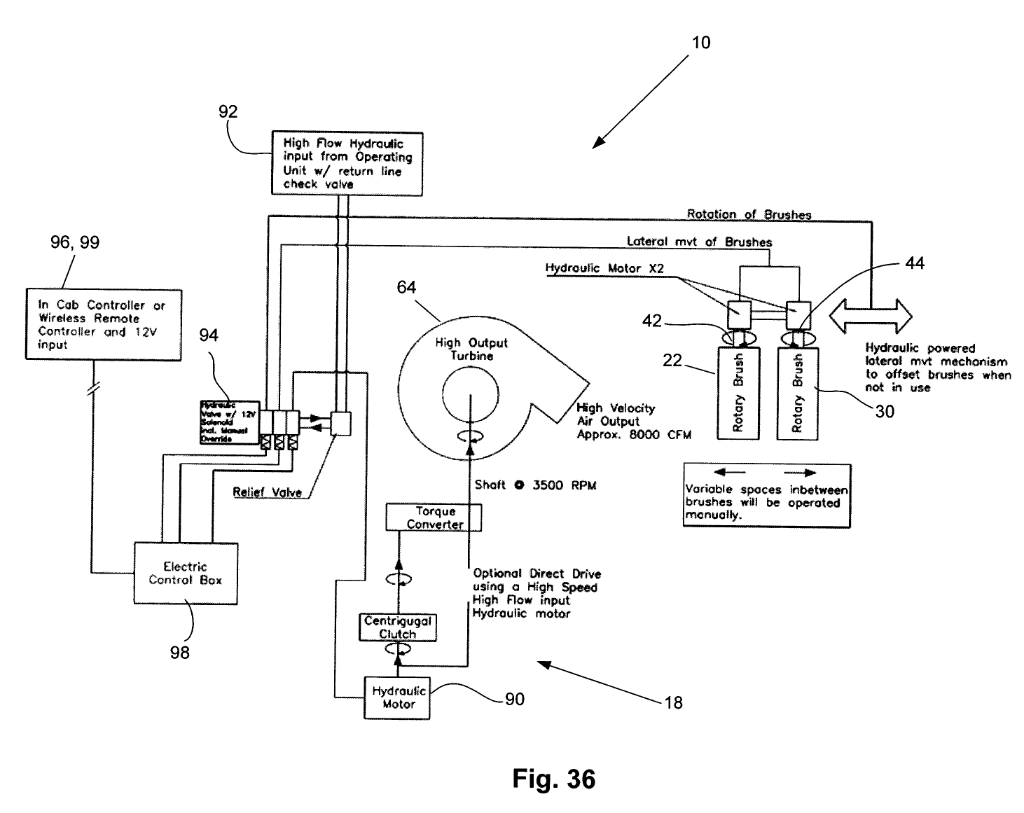

The blower device 18 further includes an opening 72 on the main frame portion 62 such as to allow entry of air into the blower device 18. Operation of the blower device 18 will be further described below, when describing FIGS. 35 and 36.

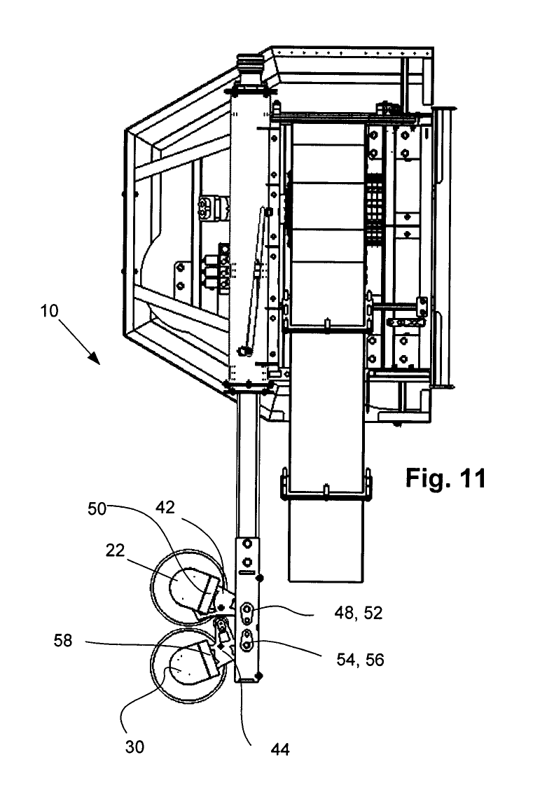

As best shown in FIG. 11, the sweeping device 20 of the device 10 includes a first arm 42 and a second arm 44 mounted on and extending from the main frame 14 such as to connect the first and second shaft members 24, 32 to the main frame 14.

The first arm 42 has a first end 48 and a second end 50. The first end 48 is coupled to the main frame 14 and extends from the main frame 14. Alternatively, the first end 48 may be pivotably coupled to the main frame 14 and extends from the main frame 14 such as to allow the first shaft member 24 to be pivoted about a first arm axis 52.

The second arm 44 has a first end 54 and a second end 56. The first end 54 is coupled to the main frame 14 and extends from the main frame 14. Alternatively, the first end 54 may be pivotably coupled to the main frame 14 and extends from the main frame 14 such as to allow the second shaft member 32 to be pivoted about a second arm axis 58. The first and second arms 42, 44 may then be displaced about the main frame 14 and the vehicle for receiving the elevated object.

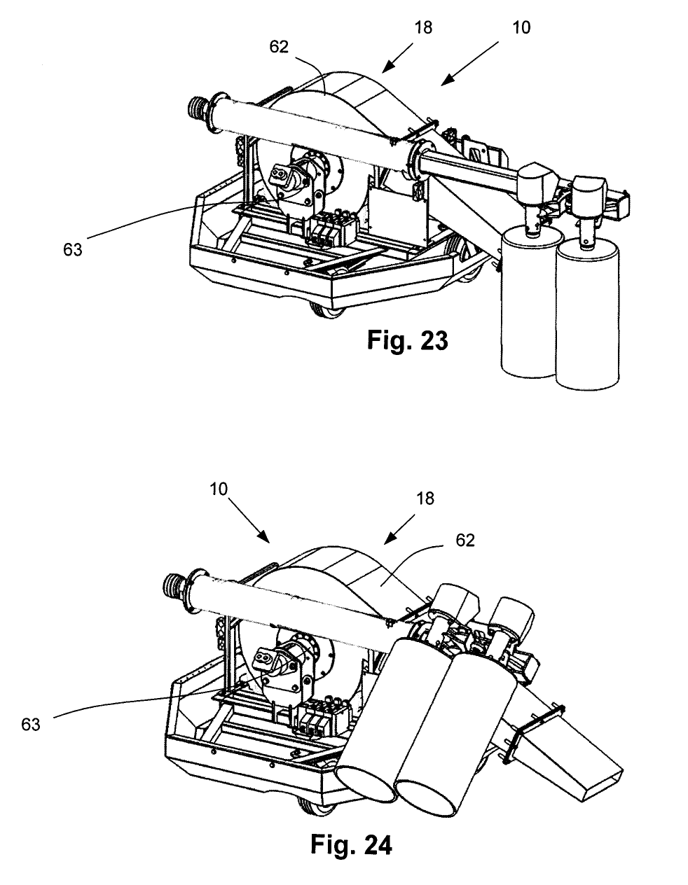

As shown in FIGS. 6, 23 and 24, first and second arms 42, 44 are mounted on an extension support 100 which extends from a hollow member 102. The extension support 100 rotates relative to the hollow member 102, thereby allowing the first and second arms 42, 44, which are fixedly mounted on the extension support 100, to be in displacement between a substantially vertical positon (FIG. 23) and a substantially inclined position (FIG. 24). For example, the internal surface (not shown) of the hollow member 102 may include a plurality of grooves or spiral grooves (not shown) for interacting with the outward extensions (not shown) of the extension support 100. A distinct motor, disposed on one end of the hollow member 102, opposite the first and second arms 42, 44, may be responsible of the displacement of the first and second arms between the substantially vertical positon (FIG. 23) and the substantially inclined position (FIG. 24).

In accordance with another embodiment (not shown), it is to be mentioned that the first and second arms 42, 44 may alternatively be independently capable of displacement between the substantially vertical position and the substantially inclined position. For example, the first arm 42 may be mounted on a first shaft (not shown) while the second arm 44 is mounted on a second shaft (not shown).

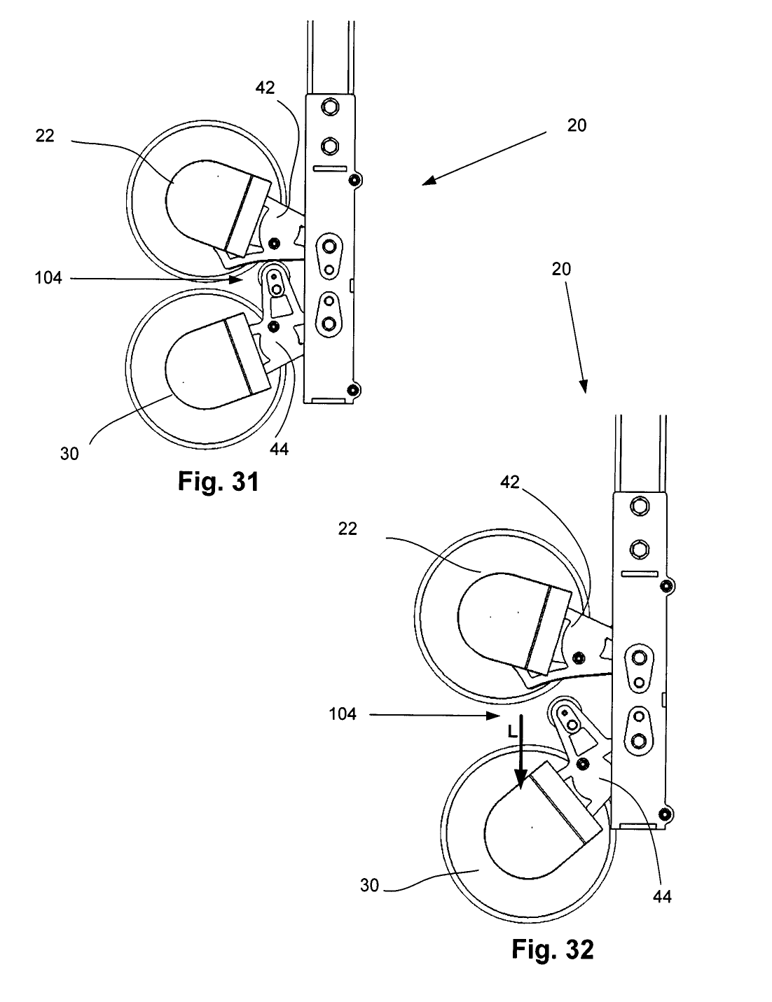

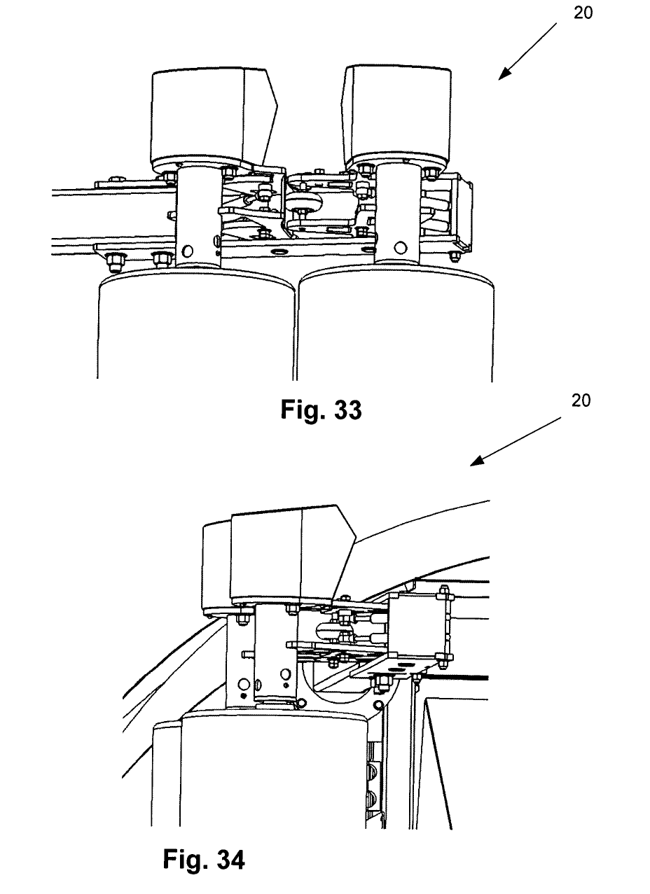

As better shown in FIGS. 31-34, each one of the first and second arms 42, 44 may further include a shock absorber mechanism 104 at their first respective ends 48, 54 in order to control the displacement of the first and second sweeping elements 22, 30 relative to the main frame 14 and to control the displacement of the first sweeping element 22 relative to the second sweeping element 30 (or the displacement of the second sweeping element 30 relative to the first sweeping element 22). The shock absorber mechanism 104 forces the first and second sweeping elements 22, 30 to each contact one side of the elevated object even when the operator does not perfectly align the sweeping device 20 with the elevated object. As shown in FIG. 31, the first and second sweeping elements 22, 33 are positioned in their initial positions (no load is applied). As shown in FIG. 32, the first sweeping element 22 is in its initial position, as the second sweeping element 30, which receives a load L from the elevated object (since the operator has not succeeded in aligning perfectly the sweeping device 20 with the elevated object), pivots and is displaced in a direction away from the first sweeping element 22. After the sweeping device 20 has passed the elevated object, the second sweeping element 30 will be redirected in its initial position as an element, since a spring element (or any suitable damping mechanism or biasing device) is included about the pivot axis of each one of the first and second sweeping elements 22, 30.

It is to be mentioned that, alternatively, only one arm may be used to couple the main frame to the first and second shaft members 24, 32.

Alternatively, the sweeping device 20 may further include adjustable arms (not shown), allowing them to retract and/or extend from the main frame 14 and the vehicle.

The sweeping device 20 may further include a motor (not shown) mounted on the main frame 14 or on the vehicle such as to operate the first and second shaft members 24, 32 and alternatively, to provide pivot to the first and second arms 42, 44 of the sweeping device 20.

The main frame 14 may further include a receiving structure 46 configured to mount the device 10 on the vehicle. The main frame 14 is also configured such as to support the components such as, the blower device 18, the sweeping device 20 and the like.

The main frame 14 may be configured to fix the device 10 to the vehicle or may be configured to attach the device 10 to the vehicle so that the device 10 can move relative to the vehicle, such as to optimize the clearing of particles from and around the elevated object.

As shown in FIGS. 1-4, the first and second sweeping elements 22, 30 are broom-like structures for removing and/or clearing an accumulation of particles on buildup on the elevated object.

Each one of the first and second sweeping elements 22, 30 may include a motor (not shown) to rotate the first and second shaft members 24, 32 about their respective first and second longitudinal axes 26, 34.

The first and second sets of bristles 28, 36 may be attached to the first and second shaft members 24, 32 and may be configured to project away from the first and second shaft members 24, 32 in a variety of ways. Actuation of the motors (alternatively, only one motor may be used for both first and second shaft members 24, 32 and for the blower device 18) rotates the first and second sets of bristles 28, 36 about the first and second longitudinal axes 26, 34, creating a sweeping effect in each sweeping elements 22, 30.

The first and second set of bristles 28, 36 may be made of natural or synthetic materials displaying one or more of the suitable characteristics such as durability, lightness or resiliency (i.e., without limitation, polymers, straw, fur, twig and the like). Bristles from the first and second set of bristles 28, 36 may be of different materials, different lengths, different sizes, different configurations and the like.

The first and second sweeping elements 22, 30 provide a sweeping area where the elevated object benefits from a sweeping effect of first and second sweeping elements 22, 30.

It is to be noted that the device 10 may include more than one sweeping device 20. For example, the device 10 may include one sweeping device 20 on one side of the main frame 14 and another sweeping device 20 on another side of the main frame 14 of the device 10. Thus, an operator would not need to guide a single sweeping device 20 from one side to another of the main frame 14, but would only need to operate the one on the side of the elevated object.

In operation of the device 10, an operator can use only the sweeping device 20 without using the blower device 18, to remove the particles (i.e., snow) from the elevated object. Alternatively, in operation of the device 10, an operator can use only the blower device 18 without using the sweeping device 20, to remove the particles (i.e., the snow) from and around the elevated object.

The device 10 may further include wiring that controls the electrical, hydraulic, hydrostatic and/or mechanical movements of the components of the device 10.

The main frame 14, the blower device 18 and/or the sweeping device 20 may further include one or a plurality of light element(s) (not shown) for illuminating elevated objects when the device 10 is in operation by an operator.

The device 10 may further include a computer system (not shown) for monitoring the location of the elevated objects and displacing the vehicle, the main frame 14, the blower device 18 (or its components) and/or the sweeping device 20 (or its component) accordingly.

As such, the operator compartment may be equipped with a computer system (not shown) for monitoring the location of the elevated objects and the location of the main frame 14 and/or the vehicle. Thus, the computer system may include a GPS.

It is to be mentioned that the device 10 may include only the blower device 18 and/or only the sweeping device 20, and not both.

The elevated object may include, without limitation, fire hydrants, traffic and parking signs, other indicators that need to be cleaned up, and the like.

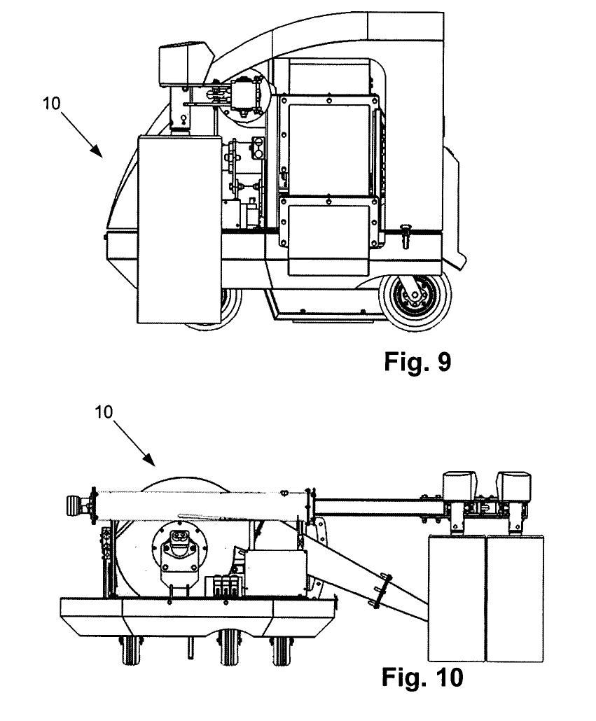

FIG. 35 is a schematic showing a device 10 for clearing an area around an elevated object operated by a fuel engine 74 which drives a hydraulic pump 76 in accordance with another embodiment. As shown, the rotary blower of the blower device 18 of the device 10 is operated by the fuel engine 74, which permits rotational movement which is transmitted through a transmission clutch 78, which permits rotational movement of the rotary blower (e.g., 3500 RPM rotary blower or any other alternative rotary blower). The fuel engine 74 further allows charging of a battery 80 and driving of a hydraulic pump 82 (e.g., 5 GPM hydraulic pump or any other alternative pump). As shown, the battery 80 provides electrical power for operation of the electronic control 84 of the device 10 as it will receive command signals from the remote control 86. On the other hand, according to the embodiment of FIG. 9, the hydraulic pump 82 is hydraulically connected to a valve 88 (e.g., hydraulic solenoid valve) which is electrically connected and controlled by the electronic control 84. The valve 88 is operatively connected with the first and second sweeping elements 22, 30 as the valve 88 can allow rotation of the first and second sweeping elements 22, 30 and/or removal of the first and second sweeping elements 22, 30. The valve 88 may further be responsible for displacement of the first and/or second longitudinal axes 26, 34 as to provide variable spaces between the brushes. The variable spaces may further be provided manually between the first and second longitudinal axes 26, 34 (and thus, the brushes).

FIG. 36 is a schematic showing a device 10 for clearing an area around an elevated object operated by a hydraulic motor 90 which is driven by auxiliary hydraulics 92 from the vehicle (not shown) in accordance with another embodiment. As shown, the rotary blower of the blower device 18 of the device 10 is operated by the hydraulic motor 90, which permits rotational movement of the rotary blower (e.g., 3500 RPM rotary blower or any other alternative rotary blower). According to the embodiment of FIG. 10, the auxiliary hydraulics 92 from the vehicle is hydraulically connected to a valve 94 (e.g., hydraulic solenoid valve) which is electrically connected and controlled by the electronic control 98. The valve 94 is operatively connected with the first and second sweeping elements 22, 30 as the valve 94 can allow rotation of the first and second sweeping elements 22, 30 and/or removal of the first and second sweeping elements 22, 30. The valve 94 may further be responsible for displacement of the first and second longitudinal axes 26, 34 as to provide variable spaces between the brushes. The variable spaces may further be provided manually between the first and second longitudinal axes 26, 34 (and thus, the brushes). The valve 94 is also hydraulically connected to the hydraulic motor 90. As shown, the electrical source 96 provides electrical power to the electronic control 98 which is electrically connected and controlled by the remote control 99.

According to another embodiment, there is provided a method for clearing particles from and around an elevated object. The method includes the step of selecting to blow the particles from and around the elevated object using a blower device 18 and/or to sweep the particles from the elevated objects using one sweeping device 20 or alternatively distant sweeping devices 20.

The device 10 for clearing an area around elevated objects may be operated by one person only.

The device 10 for clearing an area around elevated objects may clean runway edge lights and signs in a few seconds.

The device 10 for clearing an area around elevated objects may reduce and/or eliminate hand clearing of the elevated objects.

The device 10 for clearing an area around elevated objects may reduce damages to the elevated objects, such as lights, signs and indicators.

The device 10 for clearing an area around elevated objects may provide a good visibility during clearing of the elevated objects.

The device 10 for clearing an area around elevated objects may be used in various conditions including heavy snow without damaging the elevated objects, such as lights, wiring, signs and indicators.

The device 10 for clearing an area around elevated objects may be attached quickly to a vehicle.

The device 10 for clearing an area around elevated objects may be compact in size.

While preferred embodiments have been described above and illustrated in the accompanying drawings, it will be evident to those skilled in the art that modifications may be made without departing from this disclosure. Such modifications are considered as possible variants comprised in the scope of the disclosure.

1. A device for clearing an area around an elevated object, the device comprising:
a main frame;
a blower device operably mounted on the main frame for blowing high flow air towards the area around the elevated object; and
a sweeping device operably mounted to and extending from the main frame for clearing the area around the elevated object.

2. The device of claim 1, wherein the blower device comprises a rotary blower comprising:
a main frame portion mounted to the main frame; and
a turbine rotatably mounted within the main frame portion for providing the high flow air.

3. The device of claim 2, wherein the blower device further comprises a motor in driving arrangement with the turbine for operating the rotary blower.

4. The device of claim 2 or 3, wherein the blower device further comprises a high flow air outlet fluidly connected to the rotary blower for allowing the high flow air to exit the blower device in at least one of: a direction towards a surface around the elevated object and a direction towards the elevated object.

5. The device of claim 4, wherein the high flow air outlet is displaceable relative to the main frame, thereby allowing the blower device to direct the high flow air towards at least one of: the surface around the elevated object and the elevated object.

6. The device of claim 2, wherein the blower device further comprises an opening on the main frame portion for allowing entry of air into the rotary blower.

7. The device of claim 2, further comprising:
a fuel engine mounted on the main frame;
a transmission clutch in driving arrangement between the fuel engine and the rotary blower; and
an hydraulic pump in arrangement between the fuel engine and the sweeping device.

8. The device of claim 7, further comprising a valve hydraulically connected to the hydraulic pump and the sweeping device.

9. The device of claim 2, further comprising:
an hydraulic motor mounted on the main frame and in driving arrangement with the rotary blower.

10. The device of claim 9, wherein the hydraulic motor is driven by auxiliary hydraulics from a vehicle to which the device is mountable.

11. The device of claim 10, further comprising a valve hydraulically connected to the auxiliary hydraulics from the vehicle, the valve being electrically connected with the sweeping device.

12. The device of claim 1, further comprising a computer system for monitoring a location of the elevated object and displacing at least one of: a vehicle to which the device is mountable, the main frame, the blower device and the sweeping device based on the monitored location of the elevated object.

13. The device of claim 1, wherein at least one of: the main frame, the blower device and the sweeping device further comprises a light element for illuminating the elevated object.

14. The device of claim 1, wherein the sweeping device comprises:
a first sweeping element comprising a first shaft member rotatable about a first longitudinal axis, and comprising a first set of bristles projecting away from the first longitudinal axis along the first shaft member; and
a second sweeping element comprising a second shaft member rotatable about a second longitudinal axis distant from the first longitudinal axis, and comprising a second set of bristles projecting away from the second longitudinal axis along the second shaft member;
wherein the first and second shaft members rotate in proximity of the elevated object for clearing the area around the elevated object.

15. The device of claim 14, wherein the sweeping device further comprises:
a first arm mounted on and extending from the main frame; and
a second arm mounted on and extending from the main frame;
the first and second arms connecting respectively the first and second shaft members to the main frame.

16. The device of claim 15, wherein the first and second arms are respectively pivotably mounted on the main frame, thereby allowing the first sweeping element and the second sweeping element to be independently displaced relative to the main frame before.

17. The device of claim 14, wherein the sweeping device further comprises a sweeping motor operatively coupled to the first and second shaft members for operating the first and second shaft members respectively.

18. The device of claim 1, further comprising a receiving structure on the main frame for mounting the main frame on a vehicle.

19. A method for clearing an area around an elevated object, the method comprising:
blowing high flow air towards the area around the elevated object; and
sweeping the area around the elevated object using a sweeping element.

20. The method of claim 19, wherein the sweeping the area around the elevated object using a sweeping element comprises:
sweeping the area around the elevated object using at least two distant sweeping elements, whereby the elevated object passes between the at least two distant sweeping elements.
